(19) United States
(12) Patent Application Publication
(10) Pub. No.: US 2002/0159475 A1
(43) Pub. Date: Oct. 31, 2002

(54) Integrated internet and voice enabled call center

(76) Inventors: Francis Yun Tai Hung, Beijing (CN); Jiangzhe Wang, Beijing (CN); Chenshan Wu, Beijing (CN)

Correspondence Address: LAW OFFICE OF LAWRENCE E LAUBSCHER, JR, 1160 SPA RD, SUITE 2B, ANNAPOLIS, MD, 21403, US

(21) Appl. No.: 09/844,033

(22) Filed: Apr. 27, 2001

(51) Int. Cl. H04J 3/16

(52) U.S. Cl. 370/465; 370/352

(57) ABSTRACT

A system for integrating internet based inquiries into a call center operating a traditional voice based automatic call distributor (ACD) is described. The system introduces a skill based router (SBR), which interfaces with the PBX of the voice based path, to route internet based inquiries to available agents. The SBR maintains a look up table which contains information regarding agent status and agents' areas of expertise in order to provide some intelligence in the selection of agents to handle inquiries. A PBX controller instructs the voice based ACD to mark an agent to which an internet based inquiry is being directed as “unavailable” to avoid an agent from receiving both voice and internet calls at the same time.

### FIELD OF THE INVENTION

This invention relates to traditional call centers that employ automatic call distributors (ACD) to route voice based messages to call center agents and more particularly to a system and method of integrating an internet based ACD into such existing call centers.

### BACKGROUND

Automatic call distributors (ACD) are used extensively in call centers for such applications as help desks, product ordering and catalog sales centers, complaint departments, etc. Traditional call centers are designed to handle incoming telephone calls with queuing and agent selection provided by the ACD. Agent selection may be based strictly on agent availability or the selection may involve some intelligence with a view to routing a call to an agent having particular skills to deal with the caller.

As internet enabled call centers increase in popularity there is a need to provide an effective queuing system to handle both internet based inquiries and traditional telephone calls. The ideal situation would involve one queuing mechanism which includes agent status and agent skills/capabilities in the records, so that when there is an incoming voice or internet call the queuing mechanism can locate the right agent without causing voice or internet traffic conflict in the system. This solution, however, would involve a complete reconfiguration of the call center resources at considerable cost to service providers.

A typical solution is to divide the calls between two groups of agents—one group handling traditional voice traffic with the second group handling internet inquiries. This system is inflexible as agents cannot be randomly selected to support internet calls. As a result there will likely be more agents on duty at any given time than are actually required to support total service requirements.

The main difficulty in finding a satisfactory solution lies with the legacy voice ACD that currently controls the voice call distribution and which has no interaction with or prior knowledge of internet calls. There is therefore a need to provide a mechanism that is compatible with an existing voice-only ACD since there are so many voice based call centers already deployed in the field.

Current internet enabled call centers containing both PBX and web routing functionality need to find a way to coordinate calls to the same agent. The difficulty is the agent may receive a phone request from the voice ACD, as well as an inquiry from the internet. In such situations the system will have difficulties in prioritizing calls. It is a similar sort of situation to a bank teller trying to serve two customers arriving at the same time. As noted above the conventional approach is to separate the agents into two groups, one group comprising the traditional voice-only agents, and the other the multi-media voice and internet agents. Although this approach is acceptable it is generally difficult to pre-determine the break down between voice and internet traffic. Also, the deployment of agents is still inflexible since the voice ACD and the internet ACD are actually two different systems. Grouping the agents is also challenging for the call center supervisor who has to coordinate between agents' skills, available equipment and the voice or internet capability of the system.

### SUMMARY OF THE INVENTION

The present invention calls for a switch interface that can provide information regarding the operating status of each available agent. This information is fed to the internet ACD and, based on the skill set assignment, the internet ACD can determine where to send the call. To avoid receiving phone calls while the agent is serving an internet customer, the internet ACD sends a message to the PBX. This message informs the PBX to change the agent status to a ‘not available’ or a ‘logged off’ status. This stops the phone ACD from distributing any more telephone calls to the agent. Hence the agent's phone will not ring.

It is an object of the present invention to provide a solution that will provide internet enabled call center service to an existing voice based call center without abandoning the existing voice call center investment.

It is a further object of the invention to provide a solution that can provide random agent assignment of internet skills without pre-defining a pre-selected group of agents. This provides flexibility to staff up the internet service agents according to actual growth conditions.

It is a still further object of the invention to provide a solution that proportions the agent's internet calls versus the voice calls. This can range from 100% voice to 100% internet or any ratio in between. This feature provides for the sharing of internet to voice queuing times to a more desirable level. It also allows agents still in training to take on a smaller number of internet calls until they become fully familiar with the internet services.

Therefore, in accordance with a first broad aspect of the present invention there is provided an automatic call distributor (ACD) for an internet based call center comprising: receiving means to receive internet based inquiries and to derive from each inquiry relevant information regarding the nature of the inquiry; a look up table in the ACD for storing data respecting skills and availability of agents on duty; and means to match available agents having relevant skills with the inquiry and to pass the inquiry to the matching agent.

In accordance with a second broad aspect of the invention there is provided a switch interface for use in a call center to automatically route voice calls and internet based inquiries to appropriate agents comprising: a voice based automatic call distributor (ACD) to route voice calls to respective agents according to predefined protocols; an internet based ACD to route internet based inquiries to the agents based on agent information stored in tables in the internet based ACD; and means to designate certain agents as being unavailable when the certain agents are already occupied on a voice call or an internet based inquiry.

In accordance with a further aspect of the invention there is provided a method of integrating the routing of internet based inquiries with the routing of voice calls to appropriate agents at a call center employing a voice based automatic call distributor (ACD) comprising: providing an internet based ACD at said call center, said internet based ACD maintaining a look up table containing agent information respecting skills and availability of the agents; providing a switch interface to route both voice calls and internet inquiries to respective agents based on the skills and availability of the agents; and providing means to remove an agent from a list of available agents when the agent is occupied on either a voice call or an internet based inquiry.

### BRIEF DESCRIPTION OF THE DRAWINGS

The invention will now be described in greater detail with reference to the attached drawings wherein:

FIG. 1 is a block diagram showing the integration of an internet SBR and a voice ACD;

FIG. 2 illustrates the interaction between the internet SBR and voice ACD involving a voice before internet scenario;

FIG. 3 illustrates the interaction between the internet SBR and the voice ACD for an internet before voice scenario;

FIG. 4 is a flow diagram illustrating the process in which the voice ACD assigns a task to an agent;

FIG. 5 is a flow diagram illustrating the process in which a the skills based router (SBR) assigns a task to an agent;

FIG. 6 is a flow diagram illustrating a first process in which the SBR proportions internet calls versus voice calls to an agent; and

FIG. 7 is a flow diagram illustrating a second process in which the SBR proportions an agent's internet calls versus voice calls.

### DETAILED DESCRIPTION OF THE INVENTION

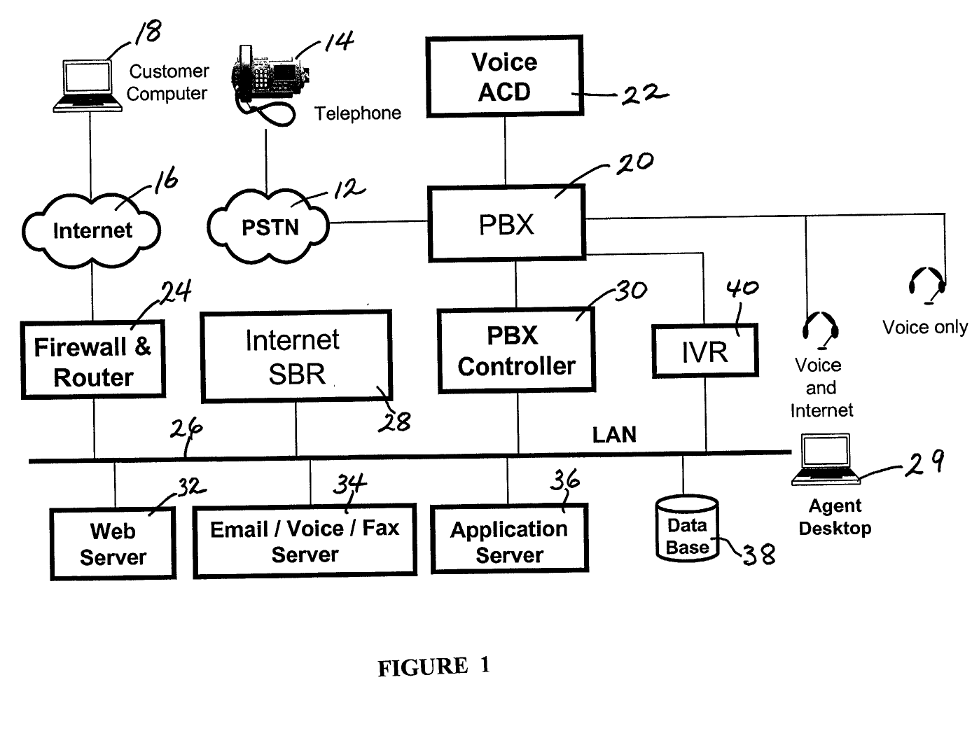

A traditional call center has a voice ACD that routes or directs incoming calls to the next available agent or in some cases to a selected agent that may have some previous knowledge relating to a particular inquiry. In the present invention an internet based ACD is integrated with a traditional voice ACD in an application such as a call center such that both voice calls and internet based inquiries can be directed to agents selected from a common pool of agents. The basic configuration of the integrated, internet enabled, call center is shown in FIG. 1.

As shown in FIG. 1 the call center includes a connection to the PSTN 12 through which a caller, via telephone 14, is able to reach the call center. Additionally, a web user or customer, with a computer 18 can connect to the call center via the internet 16. With this system a web user is able to connect to the call center via non-real time voice messages, by facsimile transmission, or via e-mail, etc. At the call center the PSTN connection is through a typical PBX switch 20. A voice based automatic call distributor 22 maintains information regarding the availability of agents and connects a caller to an agent according to system protocols.

An internet inquiry is passed through the firewall and router 24 to a Local Area Network (LAN) 26 within the call center. An internet based skills based router (SBR) 28 connected to the LAN maintains a table of available agents and provides some intelligence as to the skills of each agent in the agent pool. As shown in FIG. 1 an agent (not shown) is provided with an agent desktop 29 and is able to receive voice only access for PSTN calls or voice and internet access for handling calls from either source. Although only a single agent desktop is shown in FIG. 1 it will be apparent to one skilled in the art that in reality the call center will include an agent pool with some or all agents in the pool having voice and internet access.

A PBX controller 30 interfaces with the PBX switch 20 such that when an internet based inquiry should be forwarded to a particular agent a check is made as to the status of the agent. If the agent is not already occupied on a call, the agent is marked unavailable for a telephone call and then the internet based inquiry is routed to the agent. Also shown in FIG. 1 are other components of the call center, namely web server 32; email/voice/fax server 34; application server 36 and data base 38. An interactive voice response (IVR) unit 40 is also provided in association with the PBX switch 20 for handling interactive voice communication.

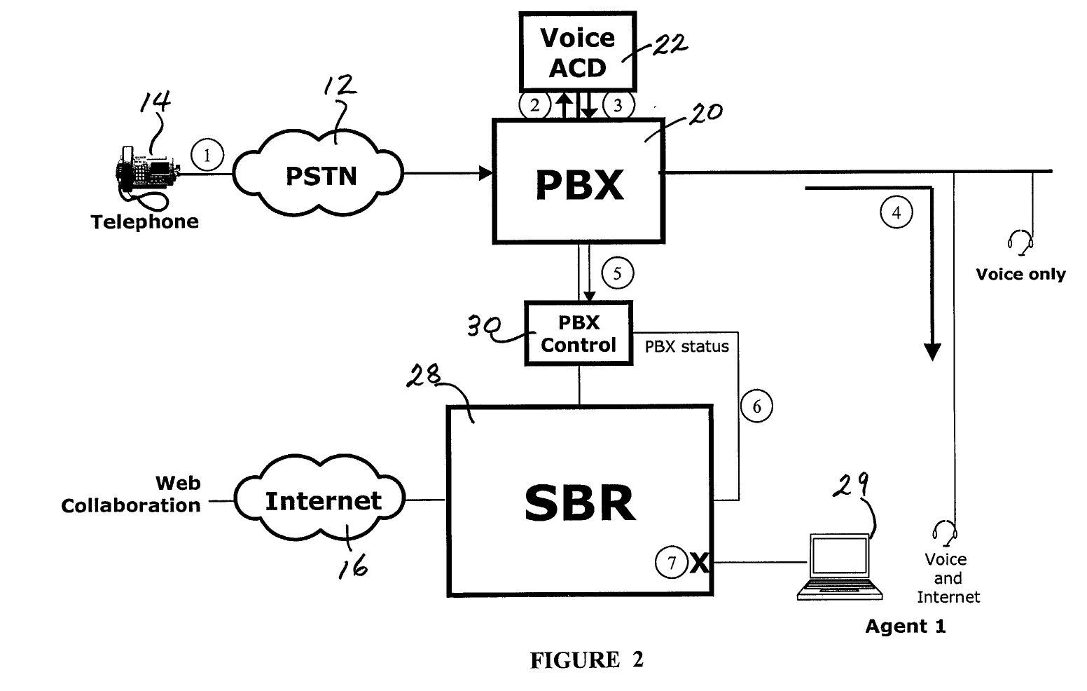

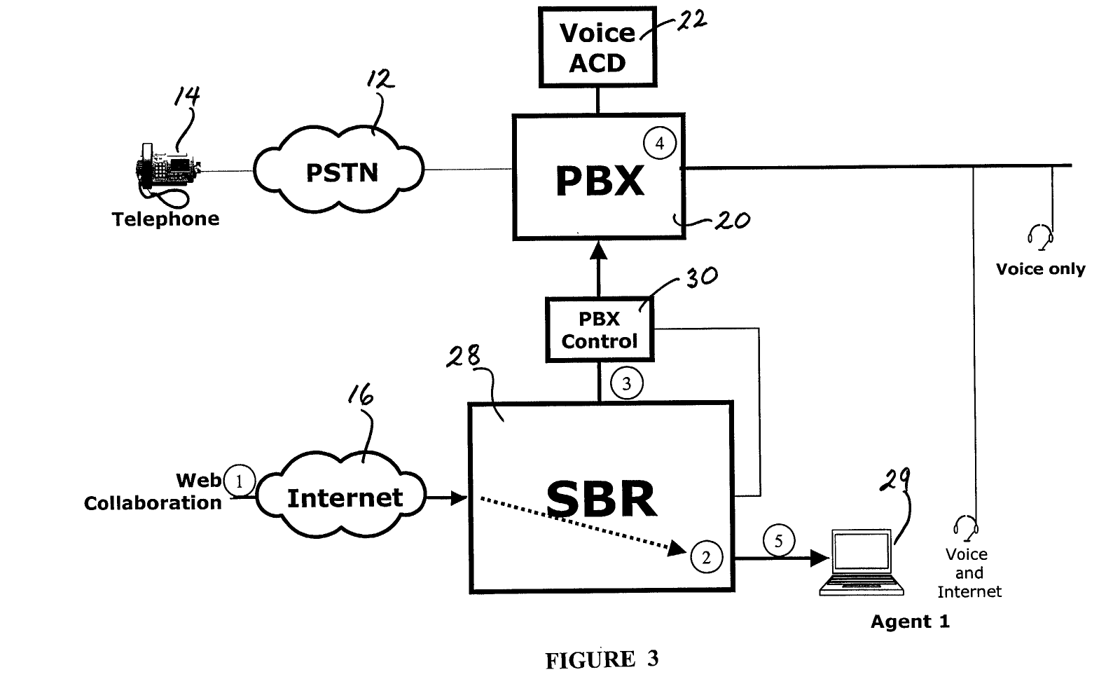

FIG. 2 illustrates the sequence of events that occur when a voice based call is given priority over an internet based inquiry. At point 1 a user places a call to the ACD over the PSTN. The PBX receives the call and passes it to the voice ACD at stage 2. At stage 3 the voice ACD instructs the PBX to set up a connection for the agent (agent 1). At step 5 the PBX advises the PBX controller that a voice call has been routed to the agent and the PBX controller notifies the SBR at step 6 that the agent's voice line is busy. At step 7 the SBR makes a notation in the SBR table that the agent (agent 1) is not available for an internet based inquiry. FIG. 3 illustrates the sequence that takes place when an internet base inquiry is given priority over a voice based call. At step 1 a client initiates an internet call. In response the SBR checks the look up table at step 2 and finds that an agent (agent 1) is available. Before the inquiry is directed to the agent, the SBR sends a command to the PBX controller for information as to phone status of the agent (step 3). If the agent's phone is not busy the PBX controller sets the agent's status as “not available” (step 4). (If the agent's phone is busy the SBR searches for another agent and repeats these steps.) After the agent's status is set as “not available” in step 4, the SBR connects the internet based inquiry to the agent at step 5.

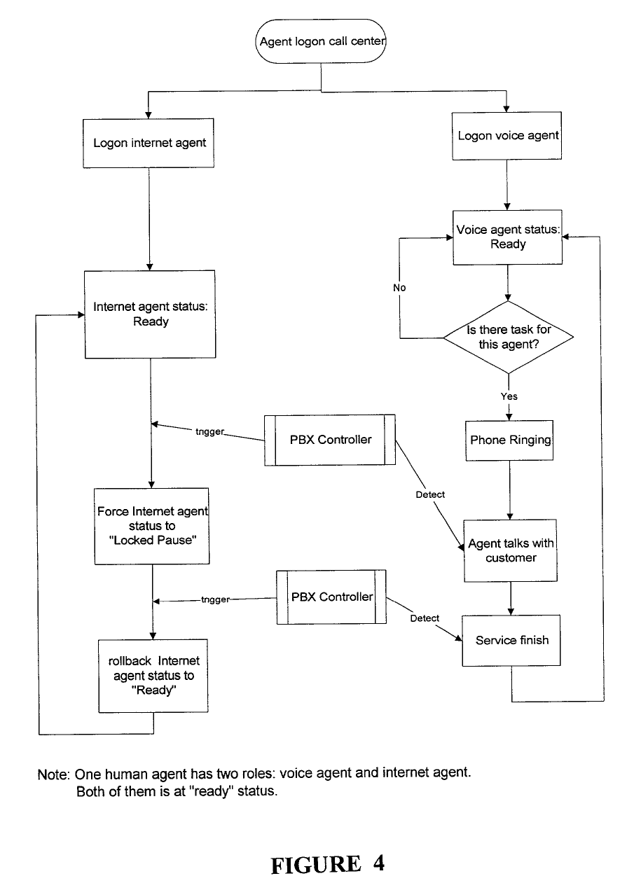

The invention as described above can be implemented in several ways as illustrated in the attached call flow diagrams (FIGS. 4 to 7). Consider a case where there is an existing voice based call center with a PBX switch as the central voice controller connecting the outside line customer to the available agent port. The voice ACD can be an internal or external server that assigns call routing to different voice based agents. The system will allow any agent to handle traditional voice or internet traffic through this integration. The SBR (skills based router) routes all internet traffic including non real time voice mail, email and fax. The PBX controller is the PBX interface module, which allows computers to control PBX connections and to query its status.

When there is a voice call arriving from the telephone network, the PBX will inform the voice ACD to make connections through traditional queuing and agent skill assignment. The SBR in the newly added internet enabled call center section contains a table which stores both information regarding the skills and availability of all agents. After the voice ACD assigns the agent with a certain line connection, the SBR will also be updated through the PBX controller. Once the agent is assigned, the SBR will not assign the agent with internet calls. FIG. 4 is a flow diagram illustrating the process steps followed in this implementation in which one agent has dual roles; voice agent and internet agent. At logon the agent is in a ready status for both voice and internet calls.

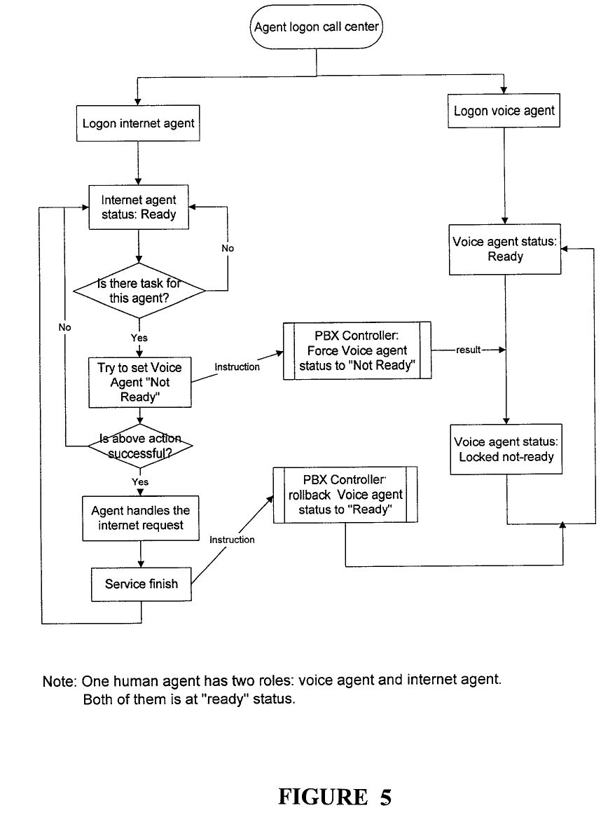

FIG. 5 is a flow diagram for the situation in which the internet SBR assigns tasks to the agent. If there is an internet call, the SBR will try to find the first available agent with the appropriate skill set. Once it finds an available agent, the SBR will note the agent found but will not make the internet connection. It will send a message to the PBX controller to set the agent as ‘busy’ or “not ready”. This way the voice ACD will not assign any new calls to that particular agent. Once the ‘set agent busy’ operation is completed, the SBR will then complete the internet connection to that agent. After the agent has handled the call the agent is returned to the “ready” status for both voice and internet calls.

In the event that an agent has already been found, and the agent suddenly changes their status to ‘not available’, the ACD and SBR will distribute the call to the next available agent. If no agent is available, the system will inform the customer that all agents are busy and put the client on hold in the waiting queue.

The SBR also has a small register that can assign each agent a voice versus internet call ratio. For example, if the default voice to internet call is a 1:1 ratio, then the agent will be taking internet and voice calls alternately; if the ratio is 2:1, then the agent will typically be answering 2 voice calls before answering the internet call. This gives the call center more flexibility in controlling voice and internet waiting time. It can also be used to set the agent's voice-to-internet handling ratio.

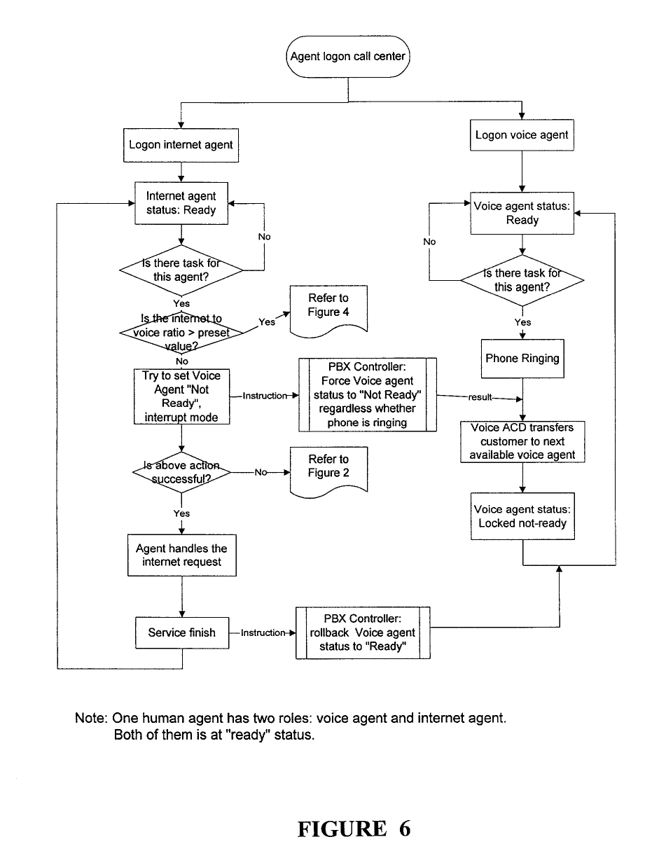

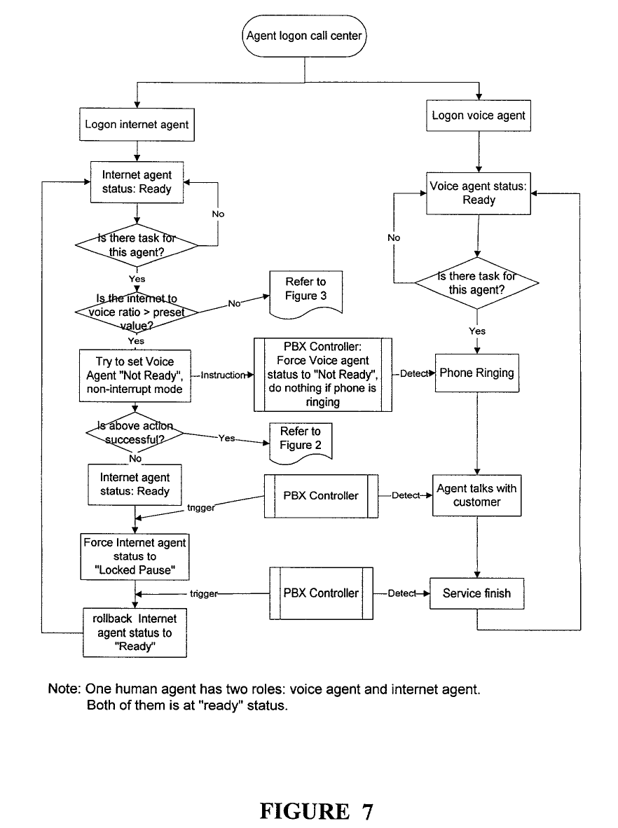

FIG. 6 and FIG. 7 are flow diagrams illustrating the process steps involved in which the SBR proportions the agent's internet calls relative to the voice calls. As shown, this process includes the decision point in which it is decided as to whether the internet to voice ratio is greater than a preset value. This preset value is determined so as to establish the aforementioned handling ratio.

FIG. 6 illustrates the situation where the ratio is less than the preset value. As shown, if the call is further processed, i.e. the ratio is less than the preset value the SBR instructs the PBX controller to force the voice status of this agent to “not ready” even if there is a voice call waiting for this agent to handle. When the internet call is complete the agent is returned to a “ready” status for both internet and voice calls.

FIG. 7 illustrates the situation where the ratio is greater than the preset threshold. In the case, the SBR checks with the PBX controller to determine whether a voice call is being directed to the agent. If there is the SBR will not intervene. If there is not the SBR will direct the internet call to the agent even if the preset ratio has been exceeded. Furthermore, if the agent is handling a voice call, the agent is then marked as not ready for an internet call until the voice call has terminated.

Although particular embodiments of the invention have been described and illustrated it will be apparent to one skilled in the art that numerous variations to those described can be implemented. It is to be understood, however, that such variations will fall within the full scope of the invention as defined broadly in the appended claims.

We claim:

1. An automatic call distributor (ACD) for an internet based call center comprising:
receiving means to receive internet based inquiries and to derive from each inquiry relevant information regarding the nature of the inquiry;
a look up table in the ACD for storing data respecting skills and availability of agents on duty; and
means to match available agents having relevant skills with the inquiry and to pass the inquiry to a selected agent.

2. An ACD as defined in claim 1 further having means to place said inquiry on hold in the event that an agent having appropriate skills is not available.

3. An ACD as defined in claim 2 wherein said internet based inquiries include non real time voice inquiries, e-mail messages and facsimile transmissions.

4. A switch interface for use in a call center to route voice calls and internet based inquiries to appropriate agents comprising:
a voice based automatic call distributor (ACD) to route voice calls to respective agents according to predefined protocols;
an internet based ACD to route internet based inquiries to selected ones of said agents based on agent information stored in tables in said internet based ACD; and
means to designate certain agents as being unavailable when said certain agents are already occupied on a voice call or an internet based inquiry.

5. A switch interface as defined in claim 4 having means to receive voice calls via the PSTN and to receive internet based inquiries from clients over the Internet.

6. A switch interface as defined in claim 5 wherein routing of said voice calls is controlled by a PBX controller in association with said voice based ACD.

7. A switch interface as defined in claim 5 wherein routing of said internet based inquiries is controlled by a skills based router (SBR) in said internet based ACD.

8. A switch interface as defined in claim 7, wherein said PBX controller and said SBR include means to control the ratio of voice calls and internet based inquiries to said agents.

9. A switch interface as defined in claim 4 having means for said agents to log on to said voice based ACD and said internet based ACD.

10. A switch interface as defined in claim 4 having means to designate said certain agents as available upon completion of a voice call or an internet based inquiry

11. A method of integrating the routing of internet based inquiries with the routing of voice calls to appropriate agents at a call center employing a voice based automatic call distributor (ACD) comprising:
providing an internet based ACD at said call center, said internet based ACD maintaining a look up table containing agent information respecting skills and availability of said agents;
providing a switch interface to route both voice calls and internet inquiries to respective agents based on the skills and availability of said agents; and
providing means to remove an agent from a list of available agents when said agent is occupied on either a voice call or an internet based inquiry.

12. The method as defined in claim 11 wherein said agents log on as voice based agents and internet based agents when they are first available to receive a call.

13. The method as defined in claim 11 including the step of monitoring the ratio of voice based calls and internet based inquiries each agent receives.

14. The method as defined in claim 13 wherein the ratio of voice based calls to internet based inquiries is variable.

15. The method as defined in claim 11 wherein said means to remove an agent from a list of available agents, returns said agent to an available list upon completion of the voice call or internet based inquiry.
